(19) United States
(12) Patent Application Publication
(10) Pub. No.: US 2009/0051569 A1
(43) Pub. Date: Feb. 26, 2009

(54) Method and system for passenger flight security

(76) Inventor: Anthony N. Pera, Coral Springs, FL (US)

Correspondence Address: Russ Weinzimmer, 614 Nashua St. #204, Milford, NH, 03055, US

(21) Appl. No.: 11/895,704

(22) Filed: Aug. 25, 2007

(51) Int. Cl. G08B 21/00

(52) U.S. Cl. 340/945

(57) ABSTRACT

An air travel security system is disclosed for preventing potential hijackers or terrorists from accessing the same bathroom during an airline flight. Bathroom keys are distributed to passengers upon boarding according to a system whereby a first passenger receives a key for a first bathroom, a second passenger receives a key for a second bathroom, etc, and/or according to the discretion of airport security personnel. In one aspect of the invention conventional keys are used, while in another aspect barcode keys are printed on passenger boarding cards. Information is also distributed to the passengers detailing the importance of the system, and of active passenger cooperation. Flight security personnel can take necessary action if a passenger does not comply with the instructions. The system offers advantages over prior art by preventing potential hijackers or terrorists from meeting in private, thus forcing them to act more conspicuously in coordinating their activities.

### FIELD OF THE INVENTION

This invention relates to air travel security, and more particularly to security methods and systems aimed at preventing the hijacking and terrorism of passenger flights.

### BACKGROUND OF THE INVENTION

Recently, and most notably since the Sep. 11, 2001 hijackings and terrorist attacks, security has become an ever growing concern at airports around the world. Security measures at major airports have increased significantly, in a variety of ways. The number of security checkpoints and personnel at these airports has grown, and security procedures are routinely implemented and universally applied. Individual passengers are being inspected thoroughly, along with their personal belongings, before they are allowed to board their flights. These and other precautions acts as both a protection and a deterrence against possible hijacker or terrorist activity, while also increasing vigilance among the passengers themselves.

Dispite these precautions, commercial airlines continue to face hijacking and terrorist threats, including the danger that a secret plot involving more than one conspirator may be initiated during the flight itself in an attempt to take over or damage the aircraft, or to harm its passengers. While airport security measures may succeed in thwarting one potential hijacker or terrorist in his or her attempt to board a flight with the means to carry out some ill intent, such security measures may not stop a whole group of accomplices who have planned together to coordinate their efforts. Coconspirators acting in concert may evade flight security personnel, while passengers remain unaware of the perpetrators' wrongful intentions. Therefore, the potential still remains that several hijackers or terrorists may successfully conspire together to seriously disrupt or take over a commercial flight, or otherwise put pasengers' lives at risk.

Bathrooms on board commercial flights allow individual passengers complete privacy. Hijackers or terrorists can take advantage of that privacy in order to assemble a bomb, or prepare some other device or means to aid their efforts. Although one potential hijacker or terrorist alone may not have all of the components necessary to prepare such device or means, several potential hijackers or terrorists, pooling their resources together, may indeed have all of the requisite components. Therefore, there exists a need for a security system that will restrict the possibility of several potential hijackers or terrorists gaining access to the same bathroom, thus minimizing the risk of a successful conspiracy to hijack or terrorize the flight. Without such a system, there remains a significant possibility that several parties may act together in secrecy, ultimately causing a significant, and potentially dangerous, disturbance to the flight.

### SUMMARY OF THE INVENTION

The invention offers advantages over existing prior art by providing a preventive security system that limits the likelihood of more than one airline passenger gaining access to a particular bathroom at the same time, or several passengers using the same bathroom towards a common purpose. This system includes distributing alternating bathroom keys to passengers as they board their flight, and only allowing passengers access to the bathroom that corresponds to their key. The restriction of passenger bathroom use to one bathroom per passenger diminishes the possibility that several potential hijackers or terrorists will be able to act together to take over or terrorize the flight.

The effectiveness of this system does not require flight security personnel to identify or apprehend potential hijackers or terrorists before any suspicious activity has taken place. Rather, the system itself is designed to inhibit the plans of potential hijackers or terrorists, by preventing them from meeting together in private. Furthermore, by forcing potential hijackers or terrorists to act more conspicuously in attempting to coordinate their activities, this system helps identify potential hijackers and terrorists to flight security personnel, while also alerting observant passengers to the threat of imminent danger.

More specifically, embodiments disclosed herein provide that bathroom keys are to be distributed to passengers as they board their flight. One such key would act as a means of identifying a passenger and providing him or her with specific bathroom entry. With each key providing one passenger with access to one, and only one, bathroom on board the flight, the keys effectively restrict bathroom access to one bathroom per passenger. The identifier bathroom keys may be metal lock keys that can be used manually by passengers to open their respective bathroom doors, or the keys may be devices of more sophisticated technology. For example, the keys may be optical technology devices, such as Universal Product Code (UPC) barcodes. As another option, the keys may be electromagnetic technology devices, such as radio-frequency identification (RFID) transponders. Broadly speaking, a key may simply be defined as a means for enabling a passenger to enter the bathroom. As an example, one such means may be a discreetly listed combination, which a passenger might refer to in order to unlock a combination lock.

The keys shall be distributed according to a pattern, such that a first passenger receives a key for a bathroom at the front of the aircraft, a second passenger receives a key for a bathroom at the back of the aircraft, and if the aircraft is so equipped, a third passenger receives a key for a bathroom at the middle of the aircraft. This process is repeated for all passengers, as they line up to board the flight. In this manner, every passenger is given a bathroom key, to be returned at the end of the flight. Flight security personnel that are present during the distribution of bathroom keys may use their discretion concerning the order in which bathroom keys are distributed.

Along with a bathroom key, an instruction manual, such as a paper pamphlet, is to be distributed to each of the passengers, detailing the purpose of the security system, and explaining the importance of passenger awareness and active participation in the identification of suspicious behavior. Passengers are further instructed to cooperate with flight security personnel, and to alert them to any perceived security threats, so that flight security personnel can help prevent a possible hijacking or terrorist act.

This invention includes the ordered distribution of identifier keys, preferably barcodes affixed to passengers' boarding passes, along with communicated instructions and information, such as in a printed pamphlet, explaining the proper usage of the keys and the importance of proactive compliance with the instructions. Other embodiments, advantages and aspects of the invention may become apparent by reading the following detailed description, and by reference to the drawings. It is understood that changes may be made to particular embodiments described in the detailed description, without departing from the spirit of the invention.

### BRIEF DESCRIPTION OF THE DRAWINGS

The invention will be more fully understood from the following detailed description, in conjunction with the accompanying figures, wherein:

FIG. 1A is a representative drawing of a possible manually operable key, illustrated as a metal lock bathroom key.

FIG. 1B is a representative drawing of a possible optical technology key, illustrated as a passenger's boarding pass with a barcode affixed to the boarding pass.

FIG. 2 is a representative drawing of a possible security instruction manual, illustrated as a printed paper pamphlet.

FIG. 3 is a diagram of an airport, showing the relationship between boarding passengers and the bathroom area locations to which they have been assigned.

FIG. 4 is a diagram of airline passengers about to board their flight, illustrating the ways in which airport security personnel may use discretion in assigning keys to passengers.

FIG. 5 is a diagram of an area of a passenger aircraft with several bathrooms, illustrating the ways in which a passenger's bathroom key is to be used.

FIG. 6 is a flowchart showing the respective roles that passengers and flight security personnel are meant to play, in accordance with the invention.

### DETAILED DESCRIPTION OF THE INVENTION

In the following detailed description of exemplary embodiments of the invention, reference is made to the accompanying drawings, which illustrate specific preferred embodiments in which the invention may be practiced. These embodiments are described in sufficient detail to enable those skilled in the art to practice the invention. It is to be understood that other embodiments may be utilized, and that logical and technical changes may readily be made without departing from the scope of the invention. Therefore, the following detailed description is not to be taken in a limiting sense, and the scope of the invention is to be limited only by the appended claims.

As used in this application, the terms “hijacker” and “terrorist” are used broadly, together referring to anyone who would deliberately seek to disrupt a commercial flight, or harm the flight's passengers, in any way. The term “airport security personnel” refers to any commercial airline employee responsible for the orderly boarding of passengers onto an aircraft for a safe and secure flight. The term “flight security personnel” refers to any personnel on board a commercial flight that are responsible for the safe and secure transportation of the flight's passengers. This includes, but is not limited to, undercover sky marshals, pilots, and flight attendants.

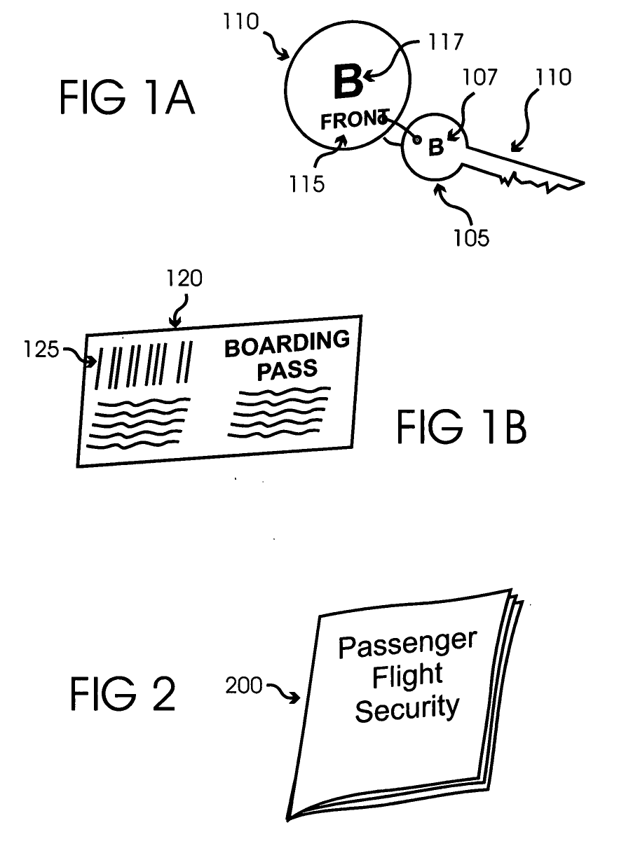

Referring to FIG. 1A, a drawing is shown of a possible manually operable, metal lock bathroom key 100, to be distributed to passengers upon boarding their flight. A tag 110 is attached to the key 100, to make the key 100 more visible and noticeable. Thus, an attempt by one passenger to give their key 200 to, or receive a different key from, another passenger, would be more easily observable by others. The tag 110 is labeled in a manner indicating whether the key is meant for a bathroom at the front, middle, or back of the aircraft 115. Further, the tag 110 and key 100 are lettered, so as to indicate a specific bathroom at the designated section of the aircraft 107, 117. This makes it clear to the passenger assigned a key 200, as well as to other passengers and to flight security personnel, which particular bathroom that passenger is supposed to be using. In consideration of the possibility that a passenger may attempt to replicate a given key 200, by taking a key impression or by other means, such manually operable bathroom keys may be rotated or changed periodically.

FIG. 1B illustrates another preferred embodiment of the bathroom key. In this drawing, the key is an optically readable barcode 125, affixed to a passenger's boarding pass 120. For example, the barcode 125 may be applied to the boarding pass 120 by means of a stamp, or non-removable sticker. Each bathroom on board the aircraft can have optical scanners connected to a locking device, and the barcode 125 can act as a key to unlock a specific bathroom. When a passenger's bathroom-specific barcode 120 is scanned by the scanner installed at the bathroom intended for that passenger, a signal can be sent to the door locking mechanism, to unlock the door so that the passenger may gain access to the bathroom. Just as in the case of the manually operable metal lock key 100, the barcode key 125 should be accompanied by annotation indicating the area on the aircraft, and specific location, of the bathroom designated for the passenger. Barcode keys 125 should be changed for every flight, to prevent passengers from replicating keys to be used for surreptitious purposes on future flights.

Other alternatives to manually operable lock keys may include, but are not limited to, radio-frequency identification (RFID) transponders, also known as RFID tags or “proximity cards”. For example, passengers may be given proximity cards with which they can unlock their designated bathroom by bringing their card into sufficiently close proximity to a detecting antenna. One such antenna may be installed at each bathroom, and connected to a locking device that unlocks the bathroom door when the correct tag is detected by the antenna. Still other alternatives will become apparent to those skilled in the art of security systems for selective controlled access, such as the present invention.

FIG. 2 shows a possible set of security instructions and related information that is to be given to each passenger, along with their respective key, upon boarding their flight. In the diagram, the set of instructions is provided in a printed hard copy, paper pamphlet 200. Other embodiments employ different means, for example, Braille, audio-cassette, or intercom announcement. The security information 200 should explain in sufficient detail the purpose of the security system, and should include instructions on how to comply with the system. The instructions should note the importance of passenger awareness, as well as active participation in identifying other passengers' failure to follow the instructions, or any other suspicious behavior of reasonable concern to flight security. Any non-compliance with the instructions inside the pamphlet 200 should be dealt with accordingly by security personnel.

In certain embodiments, including, for example, the manually operable lock key illustrated in FIG. 1A, a given passenger's key may not already be attached to their boarding pass. In such instances, each passenger's boarding pass will be stamped with a stamp depicting the same information that appears on their key 100, at the same time they receive their key 100 and pamphlet 200. Having each passenger's boarding pass stamped with the information regarding the passenger's designated bathroom enables flight security personnel to check if a given passenger has taken a bathroom key 100 that was not originally assigned to them. For example, if a passenger is exhibiting suspicious behavior, flight security personnel may ask the passenger to show them their key 100 and boarding pass, in order to check that the information displayed on their boarding pass matches the information on their key 100. In embodiments where bathroom keys 100 are Universal Product Code barcodes 125 displayed on boarding passes, the boarding pass 120 itself, with the barcode key 125 affixed thereto, will suffice to address flight security personnel inquiries.

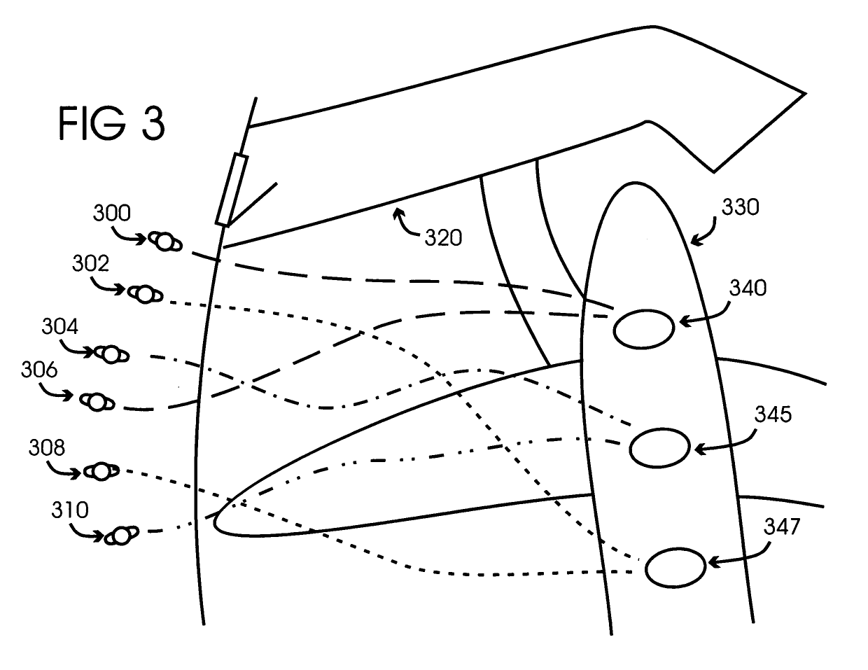

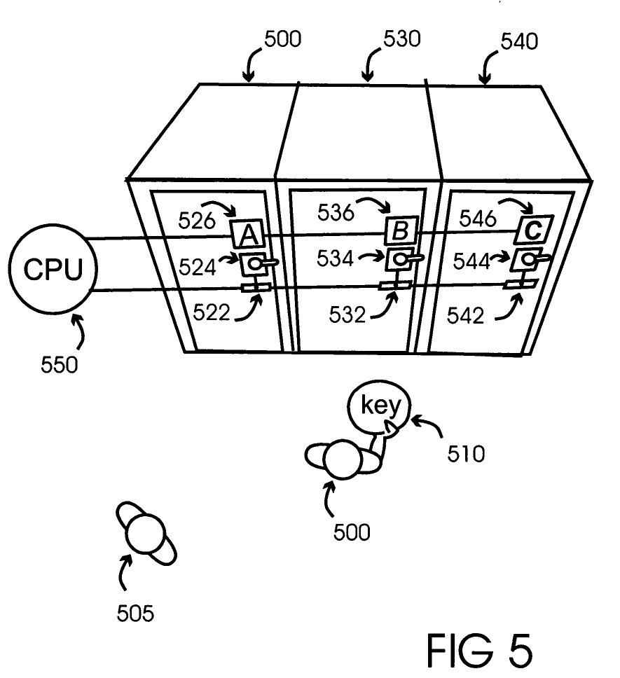

FIG. 3 is a diagram of an airport, showing the relationship between boarding passengers 302, 304, 306, 308, 310 and the bathroom area locations 340, 345, 347 to which they are being assigned. As shown, every third passenger will be assigned a key to the same bathroom area location 300, 345, 347. A first passenger 300 will receive a key for a bathroom at the front of the aircraft 340, a second passenger 302 will receive a key for a bathroom at the back of the aircraft 347, and if the aircraft is so equipped, a third passenger 304 will receive a key for a bathroom at the middle of the aircraft 345. The same process is repeated for successive passengers 306, 308, 310 as they line up to board the flight. In addition to there being several bathroom area locations 300, 345, 347 on the aircraft, each area location itself may have several bathrooms, as discussed in connection with FIG. 5. Therefore, a further added security measure should be implemented by alternating the specific bathrooms designated for successive passengers assigned to the same area. For example, after a first passenger is assigned a key for a particular bathroom in the area at the middle of the aircraft 345, the second passenger to be assigned to the area at the middle of the aircraft 345 will be designated a different particular bathroom than was the first passenger, and so on. Once each one of the bathrooms of a certain area has been assigned to a passenger, this process of rotating bathroom assignments should be repeated. Regardless of where on the aircraft a given passenger is designated to sit, they will be required to use the bathroom indicated by the key that was assigned to them. This procedure lowers the likelihood that potential hijackers or terrorists will be able to use the same bathroom, in furtherance of a conspiracy that could either disrupt the flight or harm any of the passengers in any way.

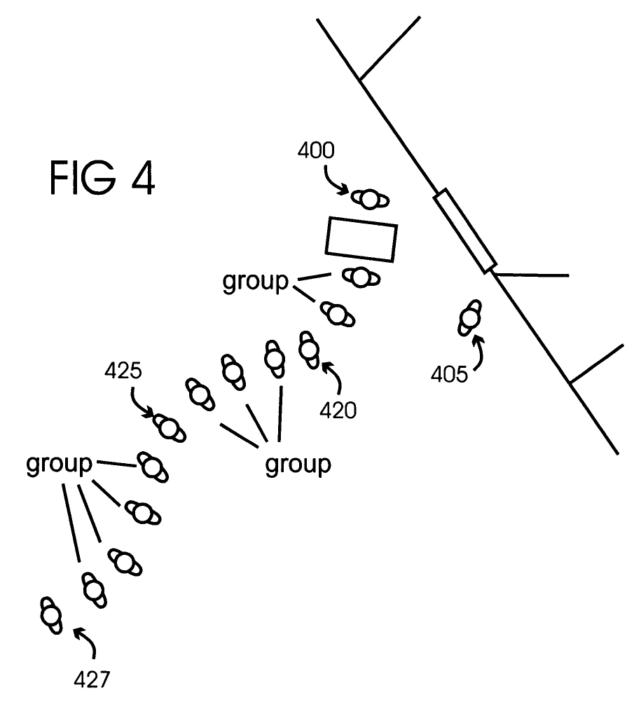

FIG. 4 is a diagram of airline passengers about to board their flight, illustrating the ways in which airport security personnel 400, 405 may use discretion in assigning keys to passengers. For example, referring to FIG. 4, there may be several passengers clearly associated in groups, and still other passengers who insist that they are flying by themselves 420, 425, 427. If airport security personnel 400, 405 deem it prudent, they may distribute keys in such a way as to be sure that certain passengers claiming to be flying alone 420, 425, 427 are given different bathroom keys from one another. Furthermore, airport security personnel may even seek to prevent assigning certain passengers to the same bathroom area location. In such instances, such passengers may be given keys to bathrooms from different locations altogether. This may be done if airport security personnel 400, 405 are reasonably suspicious of such passengers 420, 425, 427.

FIG. 4 illustrates an example of a situation in which airport security personnel may wish to use their discretion to change the pattern of distribution of bathroom keys. In the accompanying diagram, according to the same pattern discussed in connection with FIG. 3, the first solo passenger 420 is given a key for a bathroom at the middle of the aircraft, while the second solo passenger 425 is given a key for a bathroom at the front of the aircraft. Normally, the third solo passenger 427 would also be given a key for a bathroom at the middle of the aircraft, as was the first solo passenger 420. However, airport security personnel 400, 405 may choose to give the third solo passenger 427 a key for a bathroom located at the back of the aircraft, so that the third solo passenger 427 does not even share the same bathroom area location as either the first or second solo passengers 420, 425.

Alternatively, airport security personnel 400, 405 may have cause to be concerned about an entire group, and may therefore decide to change the distribution of keys in accordance with those concerns. Observant passengers may also aid airport security personnel 400, 405, by notifying them of any peculiar or otherwise suspicious behavior on the boarding line.

FIG. 5 is a diagram of an area of the aircraft with several bathrooms 520, 530, 540. From boarding time, every given passenger will have received one key, for one particular bathroom. FIG. 5 depicts a passenger 500 at the bathroom area location for which his or her key 510 was designated. If, for example, the key 510 was designated for the bathroom area location shown in the diagram, and was labeled with the letter “B”, then the passenger can only access the bathroom labeled “B” 530 at the designated bathroom area location. In an exemplary embodiment, the key 510 is a barcode that unlocks its respective bathroom 530 by being read by the scanner 532 installed at that bathroom 530, which detects whether the barcode key 510 is the correct key or the incorrect key for that bathroom. If the correct barcode key 510 is successfully scanned in, then the scanner 532 will send a signal to the bathroom door lock 534 to unlock the door.

A master computer program can be implemented to enable the bathroom scanner and lock system, and also to update barcodes for each new flight. Furthermore, the computer program's central processing unit 550 can switch and rotate the bathroom letters, such that former bathroom “A” 520 becomes bathroom “C”, former bathroom “B” 530 becomes bathroom “A”, and former bathroom “C” 540 becomes bathroom “B”, for example. Each of the scanners 522, 532, 542 at the bathrooms 520, 530, 540 will then be set to read for a new barcode, and will signal to unlock their respective bathroom door only for that new barcode. For example, after one such switch, the scanner installed at former bathroom “B” 530 will then become the scanner for new bathroom “A”, and will function in the same manner that the scanner installed at former bathroom “A” 520 had been functioning, including prompting the bathroom lock 534 to unlock the bathroom door only for passengers who scan in a barcode designated for bathroom “A”. This switching mechanism can be implemented periodically during the flight, so that a passenger may be required to use a different bathroom during one trip to a bathroom area location than he or she used during a previous trip to that bathroom area location.

For each bathroom 520, 530, 540, a monitor 526, 536, 546 connected to the central processing unit 550 of the computer program may be used to display the letter of that bathroom at any given time. When the program switches and rotates the bathroom letters for the bathrooms, the monitors 526, 536, 546 can indicate the changes accordingly. For example, referring to FIG. 5, at the instant the computer program switches the scanner installed at former bathroom “B” 532, to become the scanner for new bathroom “A”, the program also switches the monitor on the bathroom door of former bathroom “B” 536 from displaying the letter “B”, to displaying the letter “A”. Flight security personnel 505 may also periodically visit the various bathroom area locations, to help ensure that all passengers fully understand, and fully comply with, the security system.

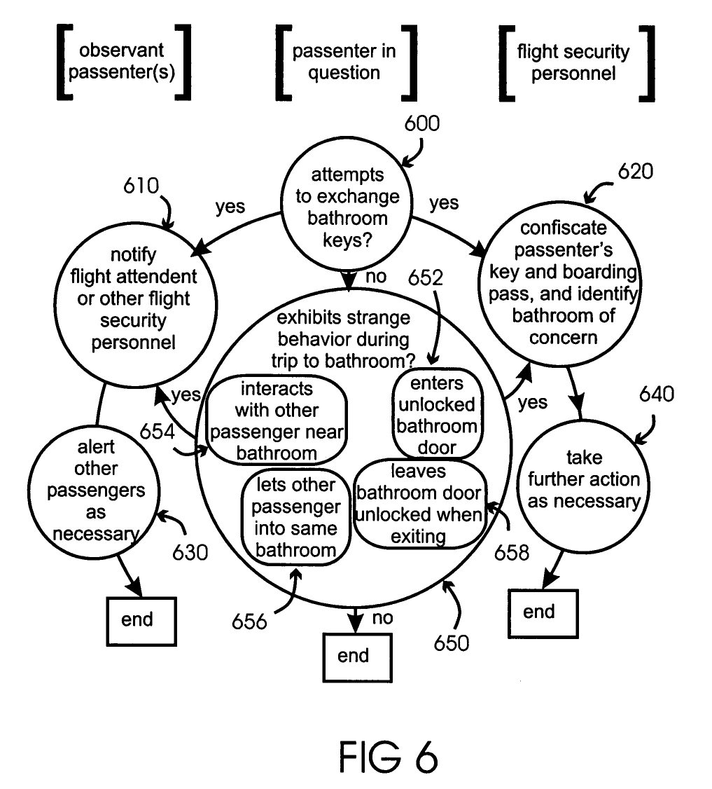

FIG. 6 is a flowchart showing the respective roles that observant passengers and flight security personnel are instructed to play in accordance with the invention. For example, if a passenger attempts to exchange his or her bathroom key with that of another passenger 600, concerned passengers should alert a flight attendant or other flight security personnel immediately 610. Flight security personnel should confiscate the passenger's bathroom key and boarding pass, and note the bathroom that the passenger was attempting to gain access to 620.

Passengers are also instructed to cooperate with flight security personnel in situations where a passenger exhibits suspicious behavior during a trip to the bathroom 650. Suspicious behavior during a trip to the bathroom 650 may include, but is not limited to: entering an unlocked bathroom door 652; interacting with another passenger while near the bathroom 654 or attempting to let another passenger into the bathroom 656; or leaving the bathroom door unlocked upon exiting the bathroom 658. If a passenger exhibits any or similar such behavior 650, other passengers witnessing such behavior once again should immediately alert a flight attendant or other flight security personnel 630, who will confiscate the passenger's bathroom key and boarding pass, and note the bathroom that the passenger was attempting to gain access to 620.

In each of the situations mentioned in connection with the accompanying flowchart in FIG. 6, passengers may also decide to alert other passengers to suspicious behavior 630, especially if flight security personnel are not immediately available. Furthermore, flight security personnel may elect to take further action, beyond the initial steps mentioned, as deemed necessary to ensure a safe and uninterrupted flight 640. For example, if a passenger's bathroom key information does not match the information stamped on their boarding pass, the bathroom they were attempting to gain access to can be searched, and all passengers assigned to that bathroom can be detained.

Although specific embodiments have been illustrated and described herein, it will be appreciated by those of ordinary skill in the art that any arrangement that is calculated to achieve the same purpose may be substituted for the specific embodiments shown. This application is intended to cover any adaptations or variations of the present invention. Therefore, it is manifestly intended that this invention be limited only by the following claims, and equivalents thereof.

What is claimed is:

1. A method for enhancing air travel security, the method comprising the steps of:
distributing a bathroom key to each passenger boarding an aircraft, and
requiring each passenger while on board the aircraft to use only the bathroom that corresponds to the key distributed to that passenger.

2. The method of claim 1, wherein the bathroom keys are distributed according to a pattern, such that:
a first passenger receives a key corresponding to a first bathroom, and each successive passenger receives a key corresponding to a bathroom that is different from previously assigned bathrooms, until one key for each available bathroom on the aircraft has been distributed to a passenger; and
the pattern of distribution is repeated until a key has been distributed to each passenger, providing each passenger with access to a particular bathroom.

3. The method of claim 1, wherein airport security personnel exercise discretion in the order of the distribution of bathroom keys to the boarding passengers.

4. The method of claim 1, wherein the bathroom keys are manually operable metal lock keys.

5. The method of claim 1, wherein the bathroom keys are radio frequency identification transponders.

6. The method of claim 1, wherein each bathroom key is labeled, by at least one of characters and phrases that refer to the specific bathroom to which the key corresponds.

7. The method of claim 6, further comprising the step of:
stamping each passenger's boarding pass with a stamp of the same specific bathroom information appearing on the passenger's bathroom key.

8. The method of claim 1, further comprising the step of:
communicating information to each passenger, explaining the purpose of the security system, and including instructions on how to comply with the system.

9. The method of claim 8, wherein the information further explains the importance of passenger awareness, and of active passenger participation in the identification of any suspicious behavior during the flight.

10. The method of claim 1, wherein passengers notify airport security personnel if any other passenger does not comply with the instructions of the security system while boarding the flight, or otherwise exhibits behavior that could be of reasonable concern to airport security.

11. The method of claim 1, wherein passengers notify flight security personnel if any other passenger does not comply with the instructions of the security system while on board the flight, or otherwise exhibits behavior that could be of reasonable concern to flight security.

12. The method of claim 1, wherein flight security personnel check to see whether a passenger's key information matches the information on the passenger's boarding pass if the passenger does not comply with the instructions of the security system while on board the flight, or otherwise exhibits behavior that could be of reasonable concern to flight security.

13. The method of claim 12, wherein flight security personnel confiscate a passenger's bathroom key and boarding pass if the information on the key and the information on the boarding pass do not match.

14. The method of claim 12, wherein flight security personnel detain all passengers with a key to the same bathroom as a passenger whose information on their key does not match the information on their boarding pass.

15. The method of claim 12, wherein flight security personnel exercise discretion in taking whatever further action the flight security personnel deem necessary.

16. A method for enhancing air travel security, the method comprising the steps of:
affixing barcodes acting as bathroom keys to the boarding passes of passengers boarding an aircraft; and
requiring each passenger while on board the aircraft to use only the bathroom that corresponds to the barcode key affixed to that passenger's boarding pass, wherein access is provided to the designated bathroom that corresponds to the barcode key affixed to the passenger's boarding pass when the barcode key is displayed and scanned by a scanner installed at the designated bathroom.

17. The method of claim 16, wherein the barcode keys are affixed to passenger boarding passes according to a pattern such that:
a first passenger receives a barcode key corresponding to a first bathroom, and each successive passenger receives a barcode key corresponding to a bathroom that is different from previously assigned bathrooms, until one barcode key for each available bathroom on the aircraft has been affixed to a passenger's boarding pass; and
the pattern of distribution is repeated until a barcode key has been distributed to each passenger.

18. The method of claim 16, wherein airport security personnel exercise discretion in the order of affixing bathroom barcode keys to passenger boarding passes.

19. The method of claim 16, wherein a computer program periodically rearranges the barcode scanner identities by changing the barcode key for which a given bathroom's scanner will unlock its respective bathroom door.

20. The method of claim 16, wherein the barcode keys are Universal Product Codes (UPC).

21. The method of claim 16, wherein each barcode key is annotated by at least one of characters and phrases that refer to the specific bathroom that the barcode key is designed to unlock.

22. The method of claim 16, further comprising the step of communicating information to each passenger explaining the purpose of the security system and including instructions on how to comply with the system.

23. The method of claim 22, wherein the information further explains the importance of passenger awareness, and of active passenger participation in the identification of any suspicious behavior during the flight.

24. The method of claim 16, wherein passengers notify airport security personnel if any other passenger does not comply with the instructions of the security system while boarding the flight, or otherwise exhibits behavior that could be of reasonable concern to airport security.

25. The method of claim 16, wherein passengers notify flight security personnel if any other passenger does not comply with the instructions of the security system while on board the flight, or otherwise exhibits behavior that could be of reasonable concern to flight security.

26. The method of claim 16, wherein flight security personnel confiscate a passenger's boarding pass if the passenger does not comply with the instructions of the security system while on board the flight, or otherwise exhibits behavior that could be of reasonable concern to flight security.

27. The method of claim 16, wherein flight security personnel detain all passengers with a barcode key to the same bathroom as a passenger who does not comply with the instructions of the security system while on board the flight, or otherwise exhibits behavior that could be of reasonable concern to flight security.

28. The method of claim 16, wherein flight security personnel exercise discretion in taking whatever further action the flight security personnel deem necessary if a passenger does not comply with the instructions of the security system while on board the flight.
